(19) United States
(12) Patent Application Publication
(10) Pub. No.: US 2025/0146869 A1
(43) Pub. Date: May 8, 2025

(54) SPECTROMETER WITH BUILT-IN CALIBRATION PATH

(71) Applicant: TRINAMIX GMBH, Ludwigshafen Am Rhein (DE)

(72) Inventors: Henning ZIMMERMANN, Ludwigshafen am Rhein (DE); Darren GOULD, Ludwigshafen am Rhein (DE); Felix SCHMIDT, Ludwigshafen am Rhein (DE); Christoph PROKOP, Ludwigshafen am Rhein (DE); Celal Mohan OEGUEN, Ludwigshafen am Rhein (DE); Michael HANKE, Ludwigshafen am Rhein (DE)

(21) Appl. No.: 18/833,137

(22) PCT Filed: Feb. 24, 2023
(86) PCT No.: PCT/EP2023/054654

§ 371 Date: Jul. 25, 2024

(30) Foreign Application Priority Data
Feb. 25, 2022 (EP) 22158769.4

(51) Int. Cl. G01J 3/02; G01J 3/08; G01J 3/10; G01J 3/42

(52) U.S. Cl. CPC G01J 3/0297; G01J 3/021; G01J 3/0262; G01J 3/08; G01J 3/10; G01J 3/42

(57) ABSTRACT

Disclosed herein is an in-use calibration method for a spectrometer device. The method includes:
providing the at least one spectrometer device including at least one optical measurement element and at least one optical calibration element having different optical properties;
providing at least one sample;
performing at least two measurements using the spectrometer device;
generating by the at least one detector at least one first detector signal S_d1 according to the measurement without the sample and at least one second detector signal S_d2 according to the measurement with the sample; and
deriving at least one calibrated optical property of the at least one sample from the first detector signal S_d1 and the second detector signal S_d2.

Further disclosed herein are a spectrometer device configured for performing an in-use calibration method and various uses thereof.

### TECHNICAL FIELD

The invention relates to an in-use calibration method for a spectrometer device, to a spectrometer device and to various uses of the spectrometer device. Such methods and devices can, in general, be used for investigating or monitoring purposes, in particular, in the infrared (IR) spectral region, especially in the near-infrared (NIR) spectral region, and in the visible (VIS) spectral region, e.g. in a spectral region allowing to mimic a human's ability of color sight. However, further applications are feasible.

### BACKGROUND ART

In general, spectrometers are known to collect information on the spectral light composition from an object, when irradiating, reflecting and/or absorbing light. In order to allow comparing spectra from multiple spectrometers, the spectrometers have to be calibrated. In general, calibration of spectrometers comprises determining intensity and wavelength of light by making use of a standardized reference sample. Thus, as an example in diffusive reflective measurements, typically a porose Polytetrafluoroethylene (PTFE) material, e.g. a disk, such as for example Spectralon® Diffuse Reflectance Standards, is used as a reflective sample, as it scatters light isotopically with same amplitude, independently from the wavelength of light impinging on it. Usually a response of the spectrometer is calibrated according to the spectrometer's response to the reference sample, wherein further a background signal, also referred to as stark signal, may be determined. In a further step, typically after determining the reference sample signal and the background signal, an actual measurement is performed thereby generating a sample signal. In conjunction, from the reference signal, the dark signal and the sample signal a unitless and calibrated, and thus comparable, number, typically either a reflectance or an absorbance, may be determined.

Such calibration methods are widely applied for analytical diffusive reflective spectroscopy (DRS) in the visible (VIS) and near-infrared (NIR) spectral region. However, such calibration schemes are typically limited to lab environments and cannot be easily transferred to more complex environments. In particular, the environment in which the spectrometer is operated may in general be able to influence the spectrometer and its components, e.g. due to a dependency on temperature, humidity, pressure, or similar environmental properties.

To lessen the impact of changes in the environment, such calibration schemes, specifically a calibration scheme using a standardized reference sample, are typically repeated regularly, often before every single operation of the spectrometer. However, performing the calibration scheme is cumbersome and thus imposes a major limitation when transferring spectrometer applications from analytical labs to more complex environments, for example to widespread consumer applications.

### Problem to be Solved

It is therefore desirable to provide methods and devices that at least substantially avoid the disadvantages of known methods and devices. In particular, it is an object of the present invention to provide methods and devices applicable in complex environments and aiming for simple compensation of environmentally induced drifts and changes in the spectrometer. Specifically, it would be desirous to have methods and devices able to allow diffusive reflective spectroscopy, for example in the VIS and NIR spectral region, to be performed without regular measurement of a diffusive reflective standard sample.

### SUMMARY

This problem is addressed by an in-use calibration method for a spectrometer device, a spectrometer device and various uses of spectrometer devices with the features of the independent claims. Advantageous embodiments which might be realized in an isolated fashion or in any arbitrary combinations are listed in the dependent claims as well as throughout the specification.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, non-withstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect, the present invention relates to an in-use calibration method for a spectrometer device. The method comprises the following steps that may be performed in the given order. However, a different order may also be possible. In particular, one, more than one or even all of the method steps may be performed once or repeatedly. Further, the method steps may be performed successively or, alternatively, two or more of the method steps may be performed in a timely overlapping fashion or even in parallel. The method may further comprise additional method steps that are not listed.

The method comprises the following steps:
a) providing the at least one spectrometer device comprising at least one optical measurement element and at least one optical calibration element having different optical properties;
b) providing at least one sample;
c) performing at least two measurements using the spectrometer device, specifically at least two consecutive measurements, wherein one of the measurements is performed with the sample and one of the measurements is performed without the sample,
   i. wherein performing the measurement with the sample comprises illuminating a detector of the spectrometer device via an optical measurement path by using the optical measurement element, the optical measurement path comprising at least one reflection at the at least one sample, and
   ii. wherein performing the measurement without the sample comprises illuminating the detector via an optical calibration path independent from the optical measurement path by using the optical calibration element, the optical calibration path comprising at least one interaction with the optical calibration element without an interaction with the sample, specifically without a reflection at the sample, and wherein the optical calibration path is arranged within the spectrometer device, specifically within a housing of the spectrometer device;
d) generating by the at least one detector at least one first detector signal S_{d1} according to the measurement without the sample and at least one second detector signal S_{d2} according to the measurement with the sample;
e) deriving at least one calibrated optical property of the at least one sample from the first detector signal S_{d1} and the second detector signal S_{d2}.

As used herein, the term “calibration” is a broad term and is to be given its ordinary and customary meaning to a person of ordinary skill in the art and is not to be limited to a special or customized meaning. The term specifically may refer, without limitation, to a process of comparing and adapting measurement values delivered by a device, e.g. a device to be calibrated, for example a spectrometer device, with those of a calibration standard of known accuracy. Thus, as an example, the calibration method may be configured to ensure that pre-defined and/or pre-specified measurement conditions, such as conditions dependent on one or more of the spectrometer components, e.g. on spectrometer hardware components, for example on the at least one detector, are fulfilled during performance of a measurement. This may specifically allow for enhancing robustness, reliability and accuracy of the measurement.

As used herein, the term “in-use calibration” is a broad term and is to be given its ordinary and customary meaning to a person of ordinary skill in the art and is not to be limited to a special or customized meaning. The term specifically may refer, to a calibration, e.g. to an adapting process, being performed under measurement conditions, such as in the same environment as the measurement. In particular, the in-use calibration for a spectrometer device may be performed in a measurement environment, such as during use of the spectrometer. Specifically, the in-use calibration may be performed when using the spectrometer device, as opposed to in a laboratory environment, e.g. opposed to in an environment having modulated and/or pre-defined conditions.

As used herein, the term “spectrometer device” is a broad term and is to be given its ordinary and customary meaning to a person of ordinary skill in the art and is not to be limited to a special or customized meaning. The term specifically may refer, without limitation, to an apparatus that is capable of recording a signal intensity, i.e. an intensity of electromagnetic radiation, such as a light intensity, the signal being generated by the detector of the spectrometer device, with respect to a corresponding wavelength of the electromagnetic radiation, i.e. a wavelength of light, or a partition thereof. Therein, the signal intensity may, preferably, be generated by the detector as an electrical signal which may then be used for deriving an optical property of a sample.

The term “sample”, as used herein is a broad term and is to be given its ordinary and customary meaning to a person of ordinary skill in the art and is not to be limited to a special or customized meaning. The term specifically may refer, without limitation, to an arbitrary object or element, chosen from a living object or a non-living object, and having at least one optical property, the determination of the optical property, preferably, being of interest to a user when using the spectrometer device.

Herein, the term “light” may generally refer to a partition of electromagnetic radiation which is, usually, referred to as “optical spectral range” and which specifically comprises one or more of the visible spectral range, the ultraviolet spectral range and the infrared spectral range. The terms “ultraviolet spectral” or “UV”, generally, refer to electromagnetic radiation having a wavelength of 1 nm to 380 nm, preferably of 100 nm to 380 nm. The term “visible”, generally, refers to a wavelength of 380 nm to 760 nm. The terms “infrared” or “IR”, generally, refer to a wavelength of 760 nm to 1000 μm, wherein a wavelength of 760 nm to 3 μm is, usually, denominated as “near infrared” or “NIR” while the wavelength of 3 u to 15 μm is, usually, denoted as “mid infrared” or “MidIR” and the wavelength of 15 μm to 1000 μm as “far infrared” or “FIR”.

The spectrometer device comprises at least one optical measurement element. The term “optical measurement element” as used herein is a broad term and is to be given its ordinary and customary meaning to a person of ordinary skill in the art and is not to be limited to a special or customized meaning. The term specifically may refer, without limitation, to an optical element configured for receiving and transferring electromagnetic radiation, i.e. light, to a detector of the spectrometer device along an optical measurement path comprising at least one reflection, specifically a diffuse reflection, at the at least one sample. Specifically, the at least one reflection at the at least one sample may be or may comprise at least one diffuse reflection and may preferably not be and not comprise a specular reflection of the electromagnetic radiation. In particular, the optical measurement element may be configured for ensuring light, e.g. emitted from at least one light-emitting element, to follow the optical measurement path. Thus, the optical measurement element may be or may comprise an optical element being used for at least partially transmitting and/or guiding the light along the optical measurement path. In particular, the optical measurement element comprises at least one of an optical filter, such as an element having optical filtering properties, an optical reflector, a dispersive element, an optical lens and a transparent window, e.g. a transparent glass window.

As used herein, the term “optical measurement path” refers to an optical path comprising at least one reflection at the sample, specifically a diffuse reflection at the sample. In particular, electromagnetic radiation, i.e. light, following and/or travelling along the optical measurement path may be emitted by at least one light emitting element, may then be reflected at the at least one sample and may subsequently illuminate the detector of the spectrometer device, wherein particularly, the light illuminating the detector may be diffusely reflected light. Thus, the optical measurement path may start at the light emitting element and may end at the detector of the spectrometer device, wherein between start and end the optical measurement path specifically comprises at least one reflection at the sample, i.e. a reflection within the sample and/or a reflection at a surface of the sample. Specifically, the optical measurement element may be arranged and/or configured such that on the optical measurement path comprises a diffuse reflection at the sample, e.g. such that the light reflected at the sample is diffusely reflected. In particular, a “diffuse reflection” may for example refer to a reflection in a way such that a light ray, e.g. incident on a surface of the sample, is scattered at many angles rather than at just one angle.

As an example, the optical measurement path may be or may comprise of two parts, such as a sample illumination path describing the first part of the optical measurement path, e.g. from the light emitting element to the sample, and a light collection path describing the second part of the optical measurement path, e.g. from the sample to the detector. Specifically, the light travelling along the collection path may be diffuse reflected light, thus, the optical measurement path may, specifically in the second part, be fanned out or split up into a plurality of partial light paths.

As used herein, the term “light-emitting element” refers to an element configured for emitting light. In particular, the light-emitting element may be or may comprise at least one light source which is known to provide sufficient emission in the optical spectral range, specifically in the visible spectral range and in the infrared spectral range, such as in the near-infrared and/or in the mid infrared and/or in the far infrared spectral range. Specifically, the light-emitting element may be selected from at least one of the following light sources: a thermal radiator, specifically an incandescent lamp or a thermal infrared emitter; a heat source; a laser diode, although further types of lasers can also be used; a light-emitting diode (LED), in particular an organic light-emitting diode, for example a light-emitting diode comprising phosphor, e.g. a phosphor LED; a structured light source.

The spectrometer device further comprises at least one optical calibration element. In particular, the optical calibration element has different optical properties than the optical measurement element. Further, the optical measurement element and the optical calibration element may be separate optical elements, such as individual elements comprising different materials having different optical properties.

The term “optical calibration element” as used herein is a broad term it is to be given its ordinary and customary meaning to a person of ordinary skill in the art and is not to be limited to a special or customized meaning. The term specifically may refer, without limitation, to an optical element configured for interacting with electromagnetic radiation in a pre-defined manner. Thus, the optical calibration element may be configured for at least one of receiving and transferring electromagnetic radiation, i.e. light, along an optical calibration path. In particular, the optical calibration element may be configured for ensuring light, e.g. emitted from at least one light emitting element, to follow the optical calibration path by interacting with the light, i.e. by at least partially reflecting or filtering the electromagnetic radiation. Thus, the optical calibration element may be or may comprise an optical element being used for interacting with, such as by at least partially transmitting and/or guiding, specifically by reflecting and/or filtering, light such that light follows the optical calibration path. In particular, the optical calibration element comprises at least one of an optical reflector, a mirror, a diffusive reflective target, an optical filter, such as an element having optical filtering properties, and a dispersive element. Additionally or alternatively, the optical calibration element may for example be an active optical calibration element, such as an active light modulator. For example, the optical calibration element may be or may comprise one or more of a switchable mirror, a switchable polarizer filter, e.g. a Liquid Crystal Display (LCD), a material having a switchable and/or changeable refractive index, e.g. by switching and/or changing between crystalline and liquid phase.

As used herein, the term “optical calibration path” refers to an optical path comprising at least one interaction of the electromagnetic radiation with the at least one optical calibration element without an interaction with the sample. The optical calibration path is arranged within the spectrometer device, i.e. within a housing of the spectrometer device. In particular, light following and/or travelling along the optical calibration path may be emitted by at least one light emitting element, may then interact with the at least one optical calibration element without interacting with the sample, specifically without being reflected at the sample, and may subsequently illuminate the detector of the spectrometer device. Thus, the optical calibration path may start at the light emitting element and may end at the detector of the spectrometer device, wherein between start and end the optical calibration path specifically comprises at least one interaction with the optical calibration element. In particular, the optical calibration path may be fully arranged within the spectrometer device. For example, the optical calibration path may fully be arranged within a housing of the spectrometer device. In particular, all parts of the optical calibration path may be arranged within the spectrometer device. Thus, as an example, starting at the at least one light emitting element, interacting with the optical calibration element and ending at the detector may all take place within the spectrometer device, i.e. within the housing of the spectrometer device.

The term “interaction with the optical calibration element” as used herein, is a broad term and is to be given its ordinary meaning to a person of ordinary skill in the art and is not to be limited to a special or customized meaning. The term specifically may refer, without limitation, to a receiving and transferring process, i.e. of electromagnetic radiation, such as of light, by using the optical calibration element. In particular, the interaction may refer to electromagnetic radiation, i.e. light, being received and transferred by the optical calibration element. As an example, light interacting with the optical calibration element may refer to a process of receiving and transferring light by using the optical calibration element, such as to a process of reflecting and/or filtering light, specifically in case the optical calibration element is selected to comprise at least one reflecting element and/or a filtering element.

As used herein, the term “illuminating a detector” is a broad term and is to be given its ordinary and customary meaning to a person of ordinary skill in the art and is not to be limited to a special or customized meaning. The term specifically may refer, without limitation, to a process of electromagnetic radiation, i.e. light, reaching the detector or at least part of the detector. In particular, the detector may be illuminated by electromagnetic radiation, i.e. light, hitting and/or reaching the detector or at least part of the detector via at least one optical path, such as via the optical measurement path or via the optical calibration path, the light, for example, being emitted by at least one light emitting element of the spectrometer device. As an example, illuminating the detector, such as the process of electromagnetic radiation, i.e. light, reaching at least part of the detector, may cause the detector to generate a signal, i.e. an electrical signal, corresponding to at least one wavelength of the electromagnetic radiation.

Specifically, in step c) i. the electromagnetic radiation, i.e. light, following and/or traveling along the optical measurement path may illuminate the detector or at least part of the detector, wherein the illumination may subsequently cause the detector to generate the at least one second detector signal S_{d2}, i.e. according to at least one wavelength of the light reflected by the sample.

In step c) ii. the electromagnetic radiation, i.e. light, following and/or travelling along the optical calibration path may illuminate the at least one detector or at least part of the at least one detector, wherein the illumination may subsequently cause the detector to generate the at least one first detector signal S_{d1}, i.e. according to at least one wavelength of the light emitted by at least one light emitting element and reflected by the at least one optical calibration element.

As an example, the at least two measurements using the spectrometer device, may be performed consecutively, such as one after the other. Specifically, a sequence of performance may be predetermined or chosen at random. In particular, the measurement with the sample may be performed before performing the measurement without the sample, or vice versa. Additionally or alternatively, the two measurements may be performed simultaneously, such as at the same time or in a timely overlapping fashion. As an example, the spectrometer device may comprise more than one, e.g. two, detectors. Specifically, simultaneous performance of the two measurements may be possible in case the spectrometer device comprises more than one detector.

Further, as used herein, the term “calibrated optical property” is a broad term and is to be given its ordinary and customary meaning to a person of ordinary skill in the art and is not to be limited to a special or customized meaning. The term specifically may refer, without limitation, to a measured optical property, wherein at least one environmental effect on the measurement is considered and compensated. In particular, the calibrated optical property of the sample may be the outcome of the in-use calibration method and may comprise information on at least one optical property of the sample, wherein environmental effects, such as degradation effects on optical parts of the spectrometer device, fully or partially have been compensated. As an example, environmental effects, such as degradation of parts of the spectrometer device, i.e. a temperature drift of a light emitting element, may be compensated in the calibrated optical property of the at least one sample derived in step e).

In particular, the calibrated optical property of the at least one sample may be one or more of an optical absorbance and an optical reflectivity of the sample. Thus, step e) may comprise deriving calibrated information on an optical absorbance and/or an optical reflectivity of the sample, such as information wherein environmental effects, such as degradation of parts of the spectrometer, are compensated.

Specifically, step e) may further comprise taking into account at least one item of pre-calibration information of the spectrometer device. Therein, the item pre-calibration information may be determined prior to performing the in-use calibration method. In particular, the item of pre-calibration information of the spectrometer device may comprise at least one factory calibration coefficient C_{fc} determined by at least one first factory signal S_{d0} and a second factory signal S_{c0}. Therein, the first factory signal S_{d0} may specifically be generated by the detector according to a factory-measurement performed with a reference sample having at least one known optical property. Further therein, the second factory signal S_{c0} may particularly be generated by the detector according to a factory-measurement performed without the reference sample.

As an example, the factory calibration coefficient C_{fc} may be determined by making use of the following equation:

$${C}_{fc} = \frac{{S}_{d 0}}{{S}_{c 0}} \qquad ( Eq . 1 )$$

As outlined above, the optical property of the sample, specifically the calibrated optical property, may specifically be or may comprise information on an optical absorbance A, such as on an absorption, of the sample. Therein, the optical absorbance A may specifically be determined by making use of the following equation:

$$A = - {log}_{10} \frac{{S}_{d 2} - {S}_{d 1}}{( {C}_{fc} - 1 ) * {S}_{d 1}} \qquad ( Eq . 2 )$$

The detector may specifically be a detector array comprising a plurality of detector elements. Thus, as an example, the signal generated by the detector depending on the illumination of the detector may specifically be dependent on an illumination of the plurality of detector elements. The term “detector array” as used herein is a broad term and is to be given its ordinary and customary meaning to a person of ordinary skill in the art and is not to be limited to a special or customized meaning. The term specifically may refer, without limitation, to a plurality of detector elements, wherein the term “plurality” particularly may refer to at least two, preferably at least four, more preferred at least eight, in particular at least sixteen, detector elements. The detector elements, as an example, may be arranged in a geometric fashion, such as in a matrix pattern and/or in a linear pattern, specifically in an equidistant row pattern. Further therein, the term “detector element” may specifically refer to an individual optical sensor, wherein each optical sensor may comprise at least one photosensitive area which is designated for recording a photoresponse of the detector element by generating at least one output signal, i.e. an electrical signal, that depends on an intensity of a portion of a wavelength signal of the electromagnetic radiation, i.e. light, illuminating the particular photosensitive area of the detector.

In particular, in case a detector array is used, the each of the factory calibration coefficient may be a multi-dimensional coefficient, e.g. a vector or matrix. Specifically, the factory calibration coefficient C_{fc}ⁱ, wherein i may refer to a detector index. Thus, the factory calibration coefficient may comprise values for each of the detector elements i of the detector array.

In a further aspect, the present invention relates to a spectrometer device configured for performing an in-use calibration. The spectrometer device comprises:
at least one detector configured for generating at least one first detector signal S_{d1} and at least one second detector signal S_{d2};
at least one light emitting element, specifically a light emitting diode (LED), configured for emitting light;
an optical measurement element configured for receiving the emitted light and transferring the emitted light to the detector along at least one optical measurement path, wherein the optical measurement path comprises at least one reflection, specifically a diffuse reflection, at at least one sample;
at least one optical calibration element having different optical properties than the optical measurement element, the optical calibration element being configured for receiving the emitted light and transferring the emitted light to the detector along at least one optical calibration path independent from the optical measurement path, the optical calibration path comprising at least one interaction with the optical calibration element without an interaction with the sample, specifically without a reflection at the sample, and wherein the optical calibration path is fully arranged within the spectrometer device;
at least one electronics unit configured for deriving from the first detector signal S_{d1} and the second detector signal S_{d2} at least one calibrated optical property of the at least one sample.

In particular, the spectrometer device may be configured for performing the in-use calibration method as outlined above or as described in more detail below. Thus, specifically with regard to the definition of terms reference may be made to the description of the in-use calibration method.

As an example, the calibrated optical property of the at least one sample derived by using the at least one electronics unit may be one or more of an optical absorbance and an optical reflectivity of the sample.

The electronics unit may further be configured for communicating with at least one data storage element having stored thereon at least one predetermined item of pre-calibration information of the spectrometer device. Specifically, when communicating with the data storage element, the electronics unit may be configured for performing a process of reading and/or writing of information on the storage element. Specifically, the electronics unit may be able to retrieve the pre-calibration information stored on the data storage element.

As an example, the electronics unit may comprise the at least one data storage element. Additionally or alternatively, the data storage element may be an external data storage connected to the electronics unit, such as for example an online storage, for example a cloud storage or the like.

In particular, the item of pre-calibration information of the spectrometer device, which may be stored on the data storage element, may be at least one factory calibration coefficient C_{fc} determined by at least one first factory signal S_{d0} and a second factory signal S_{c0}. Specifically, therein, the first factory signal S_{d0} may be generated by the detector according to a factory-measurement performed with a reference sample having at least one known optical property. Further therein, the second factory signal S_{c0} may specifically be generated by the detector according to a factory measurement performed without the reference sample. As an example, the factory calibration coefficient C_{fc} may be determined by using Eq. 1 as outlined above with regard to the in-use calibration method.

Further, the calibrated optical property of the sample may specifically be an absorbance A of the sample, wherein the electronics unit may thus be configured for determining the optical absorbance A. As an example, the electronics unit may be configured for determining the optical absorbance A by performing a calculation using Eq. 2 as outlined above with regard to the in-use calibration method.

In particular, the optical measurement element may be arranged separated from the detector, such as for example, separated by a first transparent gap, e.g. such that a volume exists between the optical measurement element and the detector through which the optical measurement path leads. Further, the optical calibration element may be arranged separated from the detector, such as by a second transparent gap, e.g. such that a volume exists between the optical calibration element and the detector through which the optical calibration path leads. However, alternatively, the optical calibration element may be arranged directly on the detector, e.g. on a side of the detector, or may even be integrated into the detector, such as between the light emitting element and a photosensitive area of the detector.

Further, the optical measurement element and the optical calibration element may be separate optical elements of the spectrometer device, such as individual elements comprising different materials and/or having different optical properties. In particular, in the spectrometer device, i.e. within a housing of the spectrometer device, the optical measurement element may be arranged separately from the optical calibration element. Thus, the measurement element and the optical calibration element may specifically be arranged in a separate location, such as in a distanced fashion and/or in a fashion spaced from each other, i.e. such that a gap exists between the optical measurement element and the optical calibration element.

The spectrometer device may, as an example, comprise at least two detectors. In particular, the first detector may specifically be configured for being illuminated by the emitted light via the at least one optical measurement path. Thus, in particular, the optical measurement path of the spectrometer device may end on the first detector. Further, the second detector may be configured for being illuminated by the emitted light via the at least one optical calibration path. Thus, as an example, the optical calibration path may end on the second detector. In particular, the first detector and the second detector may be arranged within the spectrometer device, such that the first detector is positioned at the end of the optical measurement path and the second detector is positioned at the end of the optical calibration path.

In particular, the detector may be a detector array comprising a plurality of detector elements, wherein the signal may specifically be generated by the detector depending on an illumination of the plurality of detector elements.

Further, the light emitting element of the spectrometer device may specifically be an active optical element configured for switching at least between emitting light along the optical measurement path and emitting light along the optical calibration path. As an example, the active optical element may comprise a Liquid Crystal Display (LCD) having at least two pixels for switching at least one polarizer filter. In particular, the polarizer filter may, for example, be controllable for switching between emitting light along the optical measurement path and emitting light along the optical calibration path. Additionally or alternatively, the active optical element may comprise one or more of a switchable mirror, a switchable polarizer filter, a material having a switchable and/or changeable refractive index, e.g. by switching and/or changing between crystalline and liquid phase.

As an example, the optical calibration element may be one or more of a reflector, a metal layer, a mirror, an optical filter, a diffractive element, specifically a diffractive optical element (DOE), and a dispersive element, such as a prism. Thus, specifically in this case, the interaction with the optical calibration element may be or may comprise reflecting light, e.g. at a surface of the reflector, metal layer or mirror.

Further, as an example, the optical measurement element may be a transparent window, e.g. a glass window. Specifically, the optical measurement element may be a transparent window further functioning as a sample holder and/or bearing surface.

In particular, the spectrometer device may comprise at least one further optical element arranged in one or both of the optical measurement path and the optical calibration path. Specifically, the further optical element may be one or more of an optical lens, a mirror, a reflector, an optical filter, an aperture, a diffractive optical element, a dispersive element, a light guide, specifically a tapered light guide, an optical fiber, a lenslet, e.g. a lenslet array, a collimator, a step-index material, e.g. a step-index fiber.

Furthermore, the spectrometer device may comprise at least one partitioning wall, such as at least one partition or divider, configured for reducing stray light within the spectrometer device. Specifically, the partitioning wall may be configured for reducing and/or preventing stray light from reaching the detector. Thus, the partitioning wall may be beneficial for reducing measurement noise. Further, the partitioning wall may comprise at least one cut out for allowing passage and/or transmission of light through the at least one cut out.

In a further aspect, the present invention relates to a use of a spectrometer device as described above or as outlined in further detail below. In particular, a use of the spectrometer device is proposed in an application selected from the group consisting of: an infrared detection application; a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application, in particular characterization of soil, silage, feed, crop or produce, monitoring plant health; a plastics identification and/or recycling application; a healthcare and/or beauty application, in particular a determining of skin hydration and/or oxygen saturation, e.g. in an animal or human skin, a determining of an oxygen saturation in blood, urine, saliva or other bodily fluids.

The described in-use calibration method, the spectrometer device and the proposed uses have considerable advantages over the prior art. Thus, in particular, the present methods and devices may allow the measurement of a sample, such as performing a diffusive reflective spectroscopy, without the need to measure a diffusive reflective standard sample. Specifically, cumbersome and time-consuming calibration steps, as necessary with known methods and devices, i.e. performed regularly and in some cases even before each single operation, may not be necessary with present methods and devices. Specifically, by dispensing of the necessity to perform cumbersome calibration steps, i.e. performed by professionals, the present methods and devices may allow for a faster and less complicated spectroscopy, increasing the field of application of spectroscopy. Further, the methods and devices according to the present invention may decrease the possibility of measurement errors. Specifically, the present methods and devices may be less prone to error or failure.

Furthermore, the present methods and devices may specifically be usable without the user having to be a professional. Thus, in particular, the present methods and devices may increase the field of application of spectroscopy, by allowing for transferring applications from analytical labs to a widespread consumer application. Specifically, the present methods and devices may allow simple and, still, efficient and accurate spectroscopy to be performed by non-professionals and amateurs, thereby expanding and/or spreading application of spectroscopy to a wider field of users.

In particular, the present methods and devices, by the in-use calibration, may allow for a compensation of environmental effects and/or degradation effects, such as temperature and other drifts of parts of the spectrometer device, such as of light sources, e.g. of incandescent lamps or LEDs, of dispersive elements, i.e. optical interference filters, and of detectors, specifically detectors configured for generating signals according to electromagnetic radiation in the optical spectral range, i.e. light, specifically in the visible and/or infrared spectral range and even in the near-infrared spectral range. Thus, the present methods and devices may help enable mobile application of spectroscopy, i.e. diffusive reflective spectroscopy, specifically in the visible and near-infrared spectral range, for example in smart phones and/or other wearable or portable devices, thereby allowing for a widespread application of spectroscopy, e.g. for food, health and sustainability growth.

Furthermore, the present methods and devices may allow for reducing the risk of erroneous measurements by increasing accuracy and precision of spectroscopic measurements. In particular, the present methods and devices may increase measurement precision by avoiding specular reflection, e.g. at a surface of the sample. Further, the present methods and devices may reduce interfacial effects, such as interfacial effects between probe window and sample. This may also allow increase measurement precision.

Summarizing, in the context of the present invention, and without excluding further possible embodiment, the following embodiments may be envisaged:

Embodiment 1: An in-use calibration method for a spectrometer device, the method comprising:
a) providing the at least one spectrometer device comprising at least one optical measurement element and at least one optical calibration element having different optical properties;
b) providing at least one sample;
c) performing at least two measurements using the spectrometer device, specifically at least two consecutive measurements, wherein one of the measurements is performed with the sample and one of the measurements is performed without the sample,
   i. wherein performing the measurement with the sample comprises illuminating a detector of the spectrometer device via an optical measurement path by using the optical measurement element, the optical measurement path comprising at least one reflection, specifically a diffuse reflection, at the at least one sample, and
   ii. wherein performing the measurement without the sample comprises illuminating the detector via an optical calibration path independent from the optical measurement path by using the optical calibration element, the optical calibration path comprising at least one interaction with the optical calibration element without an interaction with the sample, specifically without a reflection at the sample, and wherein the optical calibration path is arranged within the spectrometer device, specifically within a housing of the spectrometer device;
d) generating by the at least one detector at least one first detector signal S_{d1} according to the measurement without the sample and at least one second detector signal S_{d2} according to the measurement with the sample;
e) deriving at least one calibrated optical property of the at least one sample from the first detector signal and the second detector signal.

Embodiment 2: The method according to the preceding embodiment, wherein the calibrated optical property of the at least one sample is one or more of an optical absorbance and an optical reflectivity of the sample.

Embodiment 3: The method according to any one of the preceding embodiments, wherein step e) further comprises taking into account at least one item of pre-calibration information of the spectrometer device determined prior to performing the in-use calibration method.

Embodiment 4: The method according to the preceding embodiment, wherein the item of pre-calibration information of the spectrometer device comprises at least one factory calibration coefficient C_{fc} determined by at least one first factory signal S_{d0} and a second factory signal S_{c0}, wherein the first factory signal S_{d0} is generated by the detector according to a factory-measurement performed with a reference sample having at least one known optical property, and wherein the second factory signal S_{c0} is generated by the detector according to a factory-measurement performed without the reference sample.

Embodiment 5: The method according to the preceding embodiment, wherein

$${C}_{fc} = \frac{{S}_{d 0}}{{S}_{c 0}}$$

Embodiment 6: The method according to any one of the two preceding embodiments, wherein the calibrated optical property of the at least one sample is an optical absorbance A of the sample, wherein

$$A = - {log}_{10} \frac{{S}_{d 2} - {S}_{d 1}}{( {C}_{fc} - 1 ) * {S}_{d 1}}$$

Embodiment 7: The method according to any one of the preceding embodiments, wherein the detector is a detector array comprising a plurality of detector elements and wherein the signal is generated by the detector depending on an illumination of the plurality of detector elements.

Embodiment 8: A spectrometer device configured for performing an in-use calibration, the spectrometer device comprising:
at least one detector configured for generating at least one first detector signal S_{d1} and at least one second detector signal S_{d2};
at least one light emitting element, specifically a light emitting diode (LED), configured for emitting light;
an optical measurement element configured for receiving the emitted light and transferring the emitted light to the detector along at least one optical measurement path, wherein the optical measurement path comprises at least one reflection, specifically a diffuse reflection, at at least one sample;
at least one optical calibration element having different optical properties than the optical measurement element, the optical calibration element being configured for receiving the emitted light and transferring the emitted light to the detector along at least one optical calibration path independent from the optical measurement path, the optical calibration path comprising at least one interaction with the optical calibration element without an interaction with the sample, specifically without a reflection at the sample, and wherein the optical calibration path is arranged within the spectrometer device;
at least one electronics unit configured for deriving from the first detector signal S_{d1} and the second detector signal S_{d2} at least one calibrated optical property of the at least one sample.

Embodiment 9: The spectrometer device according to the preceding embodiment, wherein the spectrometer device is configured for performing the in-use calibration method according to any one of the preceding embodiments referring to an in-use calibration method.

Embodiment 10: The spectrometer device according to any one of the preceding embodiments referring to a spectrometer device, wherein the calibrated optical property of the at least one sample is one or more of an optical absorbance and an optical reflectivity of the sample.

Embodiment 11: The spectrometer device according to any one of the preceding embodiments referring to a spectrometer device, wherein the electronics unit is configured for communicating with at least one data storage element having stored thereon at least one predetermined item of pre-calibration information of the spectrometer device.

Embodiment 12: The spectrometer device according to the preceding embodiment, wherein the electronics unit further comprises the at least one data storage element.

Embodiment 13: The spectrometer device according to any one of the two preceding embodiments, wherein the item of pre-calibration information of the spectrometer device comprises at least one factory calibration coefficient C_{fc} determined by at least one first factory signal S_{d0} and a second factory signal S_{c0}, wherein the first factory signal S_{d0} is generated by the detector according to a factory-measurement performed with a reference sample having at least one known optical property, and wherein the second factory signal S_{c0} is generated by the detector according to a factory-measurement performed without the reference sample.

Embodiment 14: The spectrometer device according to the preceding embodiment, wherein

$${C}_{fc} = \frac{{S}_{d 0}}{{S}_{c 0}}$$

Embodiment 15: The spectrometer device according to any one of the two preceding embodiments, wherein the calibrated optical property of the at least one sample is an optical absorbance A of the sample, wherein the electronics unit is configured for determining the optical absorbance by performing the following calculation

$$A = - {log}_{10} \frac{{S}_{d 2} - {S}_{d 1}}{( {C}_{fc} - 1 ) * {S}_{d 1}}$$

Embodiment 16: The spectrometer device according to any one of the preceding embodiments referring to a spectrometer device, wherein the optical measurement element is arranged separated from the detector by a first transparent gap and wherein the optical calibration element is arranged separated from the detector by a second transparent gap.

Embodiment 17: The spectrometer device according to any one of the preceding embodiments referring to a spectrometer device, wherein the optical measurement element and the optical calibration element are arranged separately from each other, e.g. in separate locations, specifically such that a gap exists between the optical measurement element and the optical calibration element.

Embodiment 18: The spectrometer device according to any one of the preceding embodiments referring to a spectrometer device, wherein the spectrometer device comprises at least two detectors, wherein the first detector is configured for being illuminated by the emitted light via the at least one optical measurement path and wherein the second detector is configured for being illuminated by the emitted light via the at least one optical calibration path.

Embodiment 19: The spectrometer device according to any one of the preceding embodiments referring to a spectrometer device, wherein the detector is a detector array comprising a plurality of detector elements and wherein the signal is generated by the detector depending on an illumination of the plurality of detector elements.

Embodiment 20: The spectrometer device according to any one of the preceding embodiments referring to a spectrometer device, wherein the light emitting element is an active optical element configured for switching at least between emitting light along the optical measurement path and emitting light along the optical calibration path.

Embodiment 21: The spectrometer device according to the preceding embodiment, wherein the active optical element comprises a Liquid Crystal Display (LCD) having at least two pixels for switching at least one polarizer filter, wherein the polarizer filter is controllable for switching between emitting light along the optical measurement path and emitting light along the optical calibration path.

Embodiment 22: The spectrometer device according to any one of the preceding embodiments referring to a spectrometer device, wherein the optical calibration element is one or more of a reflector, a metal layer, a mirror, an optical filter, a diffractive element, specifically a diffractive optical element (DOE), and a dispersive element, such as a prism.

Embodiment 23: The spectrometer device according to any one of the preceding embodiments referring to a spectrometer device, wherein the optical measurement element is a transparent window.

Embodiment 24: The spectrometer device according to any one of the preceding embodiments referring to a spectrometer device, wherein the spectrometer device comprises at least one further optical element arranged in one or both of the optical measurement path and the optical calibration path, wherein the further optical element is one or more of an optical lens, a mirror, a reflector, an optical filter, an aperture, a diffractive optical element, a dispersive element, a light guide, specifically a tapered light guide, an optical fiber, a lenslet, e.g. a lenslet array, a collimator, a step-index material, e.g. a step-index fiber.

Embodiment 25: A use of a spectrometer device according to any one of the preceding embodiments referring to a spectrometer device, in an application selected from the group consisting of: an infrared detection application; a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application, in particular characterization of soil, silage, feed, crop or produce, monitoring plant health; a plastics identification and/or recycling application; a healthcare and/or beauty application, in particular a determining of skin hydration and/or oxygen saturation, e.g. in an animal or human skin, a determining of an oxygen saturation in blood, urine, saliva or other bodily fluids.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIG. 1 shows an embodiment of a spectrometer device in a schematic overview;

FIGS. 2 to 7 show different embodiments of parts of a spectrometer device in schematic overviews; and

FIG. 8 shows a flow chart of an in-use calibration method.

### DETAILED DESCRIPTION OF THE EMBODIMENTS

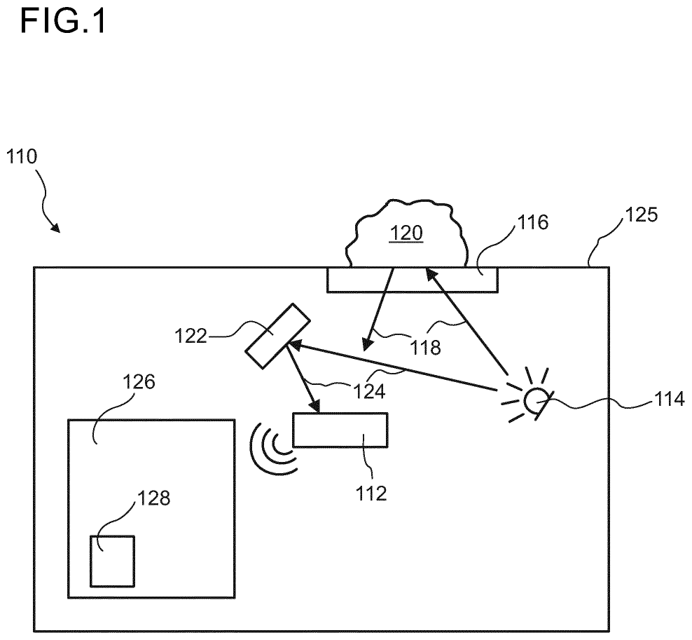

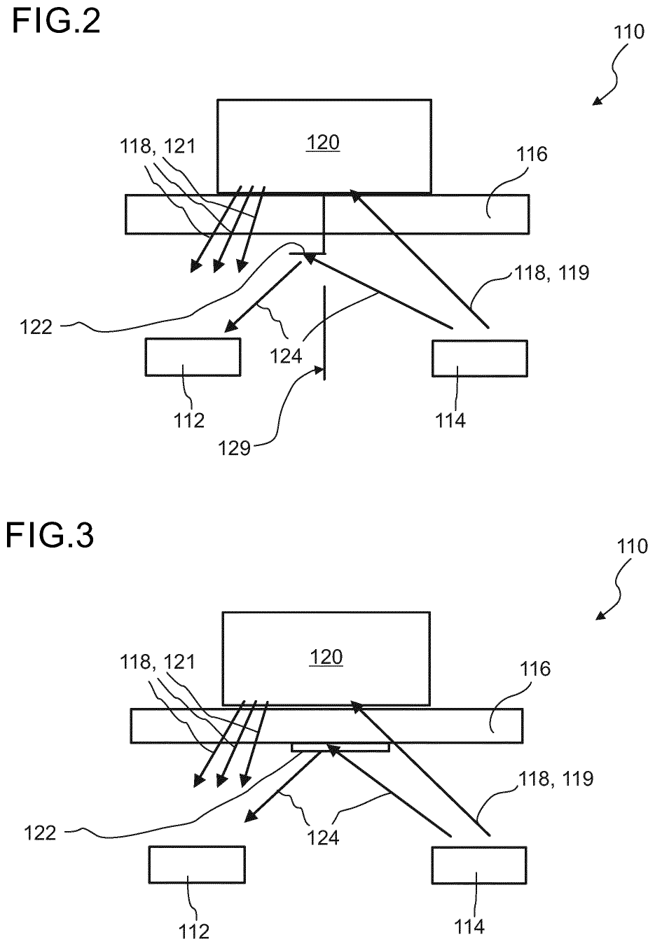

In FIG. 1, an embodiment of a spectrometer device 110 configured for performing an in-use calibration is illustrated. The spectrometer device 110 comprises at least one detector 112 configured for generating at least one first detector signal S_{d1} and at least one second detector signal S_{d2}. Further, the spectrometer device 110 comprises at least one light emitting element 114, such as an LED, configured for emitting light. Additionally, the spectrometer device 110 comprises at least one optical measurement element 116 configured for receiving the emitted light and transferring the emitted light to the detector 112 along at least one optical measurement path 118. The optical measurement path 118 comprises at least one reflection at at least one sample 120. As an example, the optical measurement path 118 may be or may comprise of two parts, such as a sample illumination path 119 describing the first part of the optical measurement path 118, e.g. from the light emitting element 114 to the sample 120, and a light collection path 121 describing the second part of the optical measurement path 118, e.g. from the sample 120 to the detector 112. Specifically, the light travelling along the collection path 121 may be diffuse reflected light, thus, the optical measurement path 118 may, specifically in the second part, be fanned out or split up into a plurality of partial light paths. Furthermore, the spectrometer device 110 comprises at least one optical calibration element 122 having different optical properties than the optical measurement element 116. The optical calibration element 122 is configured for receiving the emitted light and transferring the emitted light to the detector 112 along at least one optical calibration path 124 being independent from the optical measurement path 118. The optical calibration path 124 is arranged within the spectrometer device 110, i.e. within a housing 125 of the spectrometer device 110. Further, the optical calibration path 124 comprises at least one interaction with the optical calibration element 122 without an interaction with the sample 120. Furthermore, the spectrometer device 110 comprises at least one electronics unit 126. The electronics unit 126 is configured for deriving from the first detector signal S_{d1} and the second detector signal S_{d2} at least one calibrated optical property of the at least one sample 120. For this purpose, the detector 112 may be configured for transmitting the first and second detector signals S_{d1} and S_{d2} to the electronics unit 126, wherein in FIG. 1, this transmission is illustrated by schematic sending signals evolving from the detector 112 to the electronics unit 126. Further, the electronics unit 126 may comprise at least one data storage element 128 having stored thereon at least one predetermined item of pre-calibration information of the spectrometer device 110. Further exemplary embodiments of parts of a spectrometer device 110 are illustrated in schematic overviews in FIGS. 2, 3, 4, 5, 6 and 7.

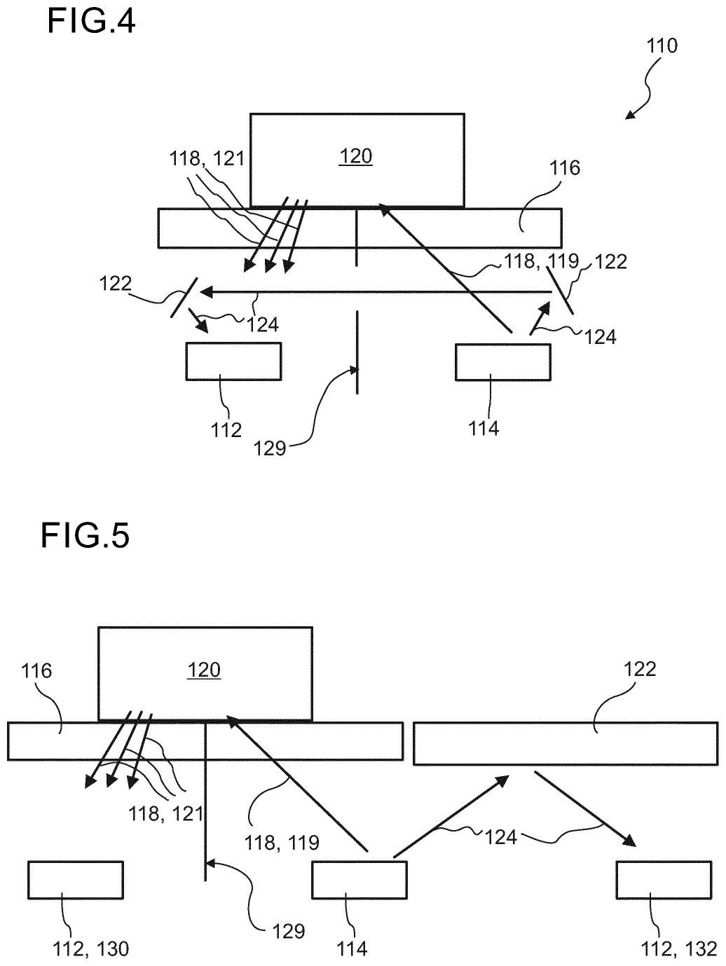

As an example, the spectrometer device 110 may further comprise at least one partitioning wall 129 configured for reducing stray light within the spectrometer device 110. In particular, the partitioning wall 129 may be configured for reducing and/or preventing stray light from reaching the detector 112. Further, as exemplarily illustrated in FIGS. 2 and 4, the partitioning wall 129 may have a cut out for selectively allowing passage and/or transmission of light, e.g. light travelling along the optical calibration path 124.

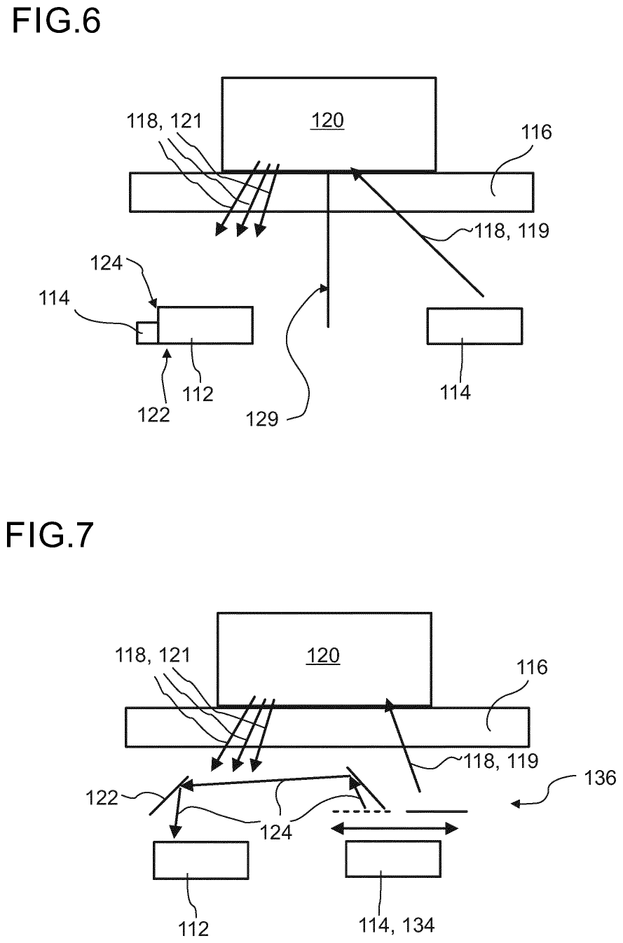

As an example, the optical measurement element 116 may be arranged separated from the detector 112 by a first transparent gap and the optical calibration element 122 may be arranged separated from the detector 112 by a second transparent gap. However, and as is exemplarily illustrated in FIG. 6, the optical calibration element 122 may be integrated into the detector 112, such as between the light emitting element 114 and for example a photosensitive area of the detector 112. As further exemplarily illustrated in FIG. 6, the spectrometer device 110 may comprise more than one light emitting element 114, such as at least two light emitting elements 114, wherein one light emitting element 114, such as the light emitting element 114 illustrated on the left side in FIG. 6, may be used for emitting light along the optical calibration path 124, wherein the at least one other light emitting element 114, e.g. the light emitting element 114 illustrated on the right side in FIG. 6, may be used for emitting light along the optical measurement path 118.

Further, the optical measurement element 116 and the optical calibration element 122 may be arranged separately from each other. Thus, as exemplarily illustrated at least in FIG. 2, a gap may exist between the optical measurement element 116 and the optical calibration element 122. However, as exemplarily illustrated in FIG. 3, the optical calibration element 122 may alternatively be arranged directly on the optical measurement element 116, e.g. on a side of the optical measurement element 116, specifically on a side of the optical measurement element 116 facing the light emitting element 114 and preferably the detector 112. Furthermore, e.g. additionally or alternatively, the spectrometer device 110 may comprise a plurality of optical calibration elements 122, such as at least two optical calibration elements 122, as exemplarily illustrated in FIG. 4.

Furthermore, and as exemplarily illustrated in FIG. 5, the spectrometer device 110 may comprise at least two detectors 112, such as a first detector 130 and a second detector 132. In this arrangement, the first detector 130 may be configured for being illuminated by the emitted light, i.e. emitted by the light emitting element 114, via the at least one optical measurement path 118, wherein the second detector 132 may be configured for being illuminated by the emitted light via the at least one optical calibration path 124. In particular, in this embodiment, the spectrometer device 110 may be able for simultaneously performing at least two measurements, wherein one of the measurements may be performed with the sample 120, e.g. by illuminating the first detector 130 via the optical measurement path 118, and one of the measurements may be performed without the sample 120, e.g. by illuminating the second detector 132 via the optical calibration path 124.

The light emitting element 114, as an example, may be an active optical element 134. Specifically, and as exemplarily illustrated in FIG. 7, the light emitting element 114 being an active optical element 134 may be configured for switching at least between emitting light along the optical measurement path 118 and emitting light along the optical calibration path 124. The switching between emitting light along the optical measurement path 118 and along the optical calibration path 124 is illustrated in FIG. 7 by the left right arrow. Specifically, the active optical element 134 may comprise a Liquid Crystal Display 136 having at least two pixels for switching at least one polarizer filter. The polarizer filter may specifically be controllable for switching between emitting light along the optical measurement path 118 and emitting light along the optical calibration path 124.

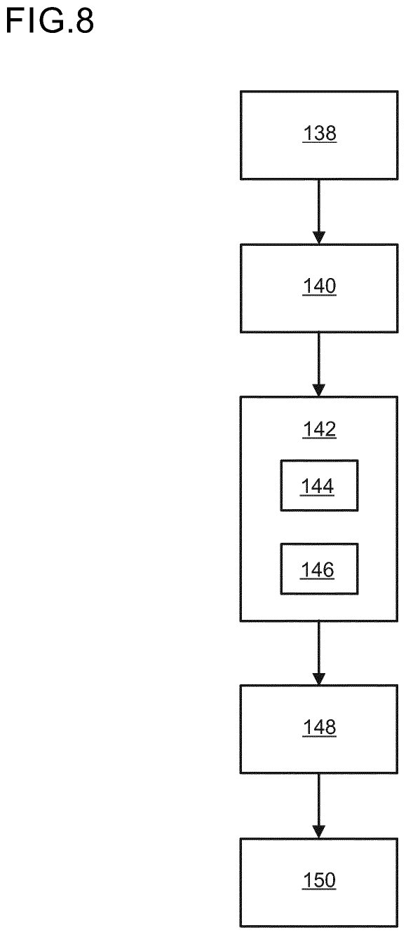

The spectrometer device 110 may specifically be configured for performing an in-use calibration method. In FIG. 8, a flow chart of an in-use calibration method is illustrated. The in-use calibration method comprises the following steps:
a) (denoted with reference number 138) providing the at least one spectrometer device 110 comprising at least one optical measurement element 116 and at least one optical calibration element 122 having different optical properties;
b) (denoted with reference number 140) providing at least one sample 120;
c) (denoted with reference number 142) performing at least two measurements using the spectrometer device 110, specifically at least two consecutive measurements, wherein one of the measurements is performed with the sample 120 and one of the measurements is performed without the sample 120,
   i. (denoted with reference number 144) wherein performing the measurement with the sample 120 comprises illuminating a detector 112 of the spectrometer device 110 via an optical measurement path 118 by using the optical measurement element 116, the optical measurement path 118 comprising at least one reflection at the at least one sample 120, and
   ii. (denoted with reference number 146) wherein performing the measurement without the sample 120 comprises illuminating the detector 112 via an optical calibration path 124 independent from the optical measurement path 118 by using the optical calibration element 122, the optical calibration path 124 comprising at least one interaction with the optical calibration element 122 without an interaction with the sample 120 and wherein the optical calibration path 124 is arranged within the spectrometer device 110, specifically within a housing 125 of the spectrometer device;
d) (denoted with reference number 148) generating by the at least one detector 112 at least one first detector signal S_{d1} according to the measurement without the sample 120 and at least one second detector signal S_{d2} according to the measurement with the sample 120;
e) (denoted with reference number 150) deriving at least one calibrated optical property of the at least one sample 120 from the first detector signal and the second detector signal.

As an example, step e) may further comprise taking into account at least one item of pre-calibration information of the spectrometer device 110 determined prior to performing the in-use calibration method. In particular, the item of pre-calibrated information of the spectrometer device 110 may comprise at least one factory calibration coefficient C_{fc} determined by at least one first factory signal S_{d0} and a second factory signal S_{c0}. The first factory signal S_{d0} may specifically be generated by the detector 112 according to a factory-measurement performed with a reference sample having at least one known optical property. The second factory signal S_{c0} may specifically be generated by the detector 112 according to a factory-measurement performed without the reference sample. In particular, the factory calibration coefficient C_{fc} may be determined by using Eq. 1 as outlined above.

Furthermore, the calibrated optical property of the at least one sample 120 may be an optical absorbance A of the sample (120), wherein the optical absorbance A of the sample may specifically be determined by using Eq. 2 as outlined above.

### LIST OF REFERENCE NUMBERS

110 spectrometer device
112 detector
114 light emitting element
116 optical measurement element
118 optical measurement path
119 sample illumination path
120 sample
121 light collection path
122 optical calibration element
124 optical calibration path
125 housing
126 electronics unit
128 data storage element
129 partitioning wall
130 first detector
132 second detector
134 active optical element
136 liquid crystal display
138 step a)
140 step b)
142 step c)
144 substep i.
146 substep ii.
148 step d)
150 step e)

1. An in-use calibration method for a spectrometer device, the method comprising:
a) providing the at least one spectrometer device comprising at least one optical measurement element and at least one optical calibration element having different optical properties, wherein the spectrometer device comprises at least two detectors, wherein the first detector is configured for being illuminated by emitted light via at least one optical measurement path and wherein the second detector is configured for being illuminated by emitted light via at least one optical calibration path;
b) providing at least one sample;
c) performing at least two measurements using the spectrometer device, wherein one of the measurements is performed with the sample and one of the measurements is performed without the sample,
i. wherein performing the measurement with the sample comprises illuminating the first detector of the spectrometer device via the optical measurement path by using the optical measurement element, the optical measurement path comprising at least one reflection at the at least one sample, and
ii. wherein performing the measurement without the sample comprises illuminating the second detector via the optical calibration path independent from the optical measurement path by using the optical calibration element, the optical calibration path comprising at least one interaction with the optical calibration element without an interaction the sample and wherein the optical calibration path is arranged within the spectrometer device, specifically within a housing of the spectrometer device;
wherein the two measurements are performed simultaneously;
d) generating by the at least one detector at least one first detector signal S_{d1} according to the measurement without the sample and at least one second detector signal S_{d2} according to the measurement with the sample; and
e) deriving at least one calibrated optical property of the at least one sample from the first detector signal S_{d1} and the second detector signal S_{d2}.

2. The method according to claim 1, wherein step e) further comprises taking into account at least one item of pre-calibration information of the spectrometer device determined prior to performing the in-use calibration method.

3. The method according to claim 2, wherein the item of pre-calibration information of the spectrometer device comprises at least one factory calibration coefficient C_{fc} determined by at least one first factory signal S_{d0} and a second factory signal S_{c0}, wherein the first factory signal S_{d0} is generated by the detector according to a factory-measurement performed with a reference sample having at least one known optical property, and wherein the second factory signal S_{c0} is generated by the detector according to a factory-measurement performed without the reference sample, wherein
$${C}_{fc} = \frac{{S}_{d 0}}{{S}_{c 0}} .$$

4. The method according to claim 2, wherein the calibrated optical property of the at least one sample is an optical absorbance A of the sample, wherein
$$A = - {log}_{10} \frac{{S}_{d 2} - {S}_{d 1}}{( {C}_{fc} - 1 ) * {S}_{d 1}} .$$

5. A spectrometer device configured for performing an in-use calibration, the spectrometer device comprising:
at least one detector configured for generating at least one first detector signal S_{d1} and at least one second detector signal S_{d2};
at least one light emitting element configured for emitting light;
an optical measurement element configured for receiving the emitted light and transferring the emitted light to the detector along at least one optical measurement path, wherein the optical measurement path comprises at least one reflection at at least one sample;
at least one optical calibration element having different optical properties than the optical measurement element, the optical calibration element being configured for receiving the emitted light and transferring the emitted light to the detector along at least one optical calibration path independent from the optical measurement path, the optical calibration path comprising at least one interaction with the optical calibration element without an interaction with the sample and wherein the optical calibration path is arranged within the spectrometer device; and
at least one electronics unit configured for deriving from the first detector signal S_{d1} and the second detector signal S_{d2} at least one calibrated optical property of the at least one sample;
wherein the spectrometer device comprises at least two detectors, wherein the first detector is configured for being illuminated by the emitted light via the at least one optical measurement path and wherein the second detector is configured for being illuminated by the emitted light via the at least one optical calibration path.

6. The spectrometer device according to claim 5, wherein the spectrometer device is configured for performing an in-use calibration method.

7. The spectrometer device claim 5, wherein the electronics unit is configured for communicating with at least one data storage element having stored thereon at least one predetermined item of pre-calibration information of the spectrometer device.

8. The spectrometer device according to claim 7, wherein the item of pre-calibration information of the spectrometer device comprises at least one factory calibration coefficient C_{fc} determined by at least one first factory signal S_{d0} and a second factory signal S_{c0}, wherein the first factory signal S_{d0} is generated by the detector according to a factory-measurement performed with a reference sample having at least one known optical property, and wherein the second factory signal S_{c0} is generated by the detector according to a factory-measurement performed without the reference sample, wherein
$${C}_{f c} = \frac{{S}_{d 0}}{{S}_{c 0}} .$$

9. The spectrometer device according to claim 7, wherein the calibrated optical property of the at least one sample is an optical absorbance A of the sample, wherein the electronics unit is configured for determining the optical absorbance by performing the following calculation
$$A = - {log}_{10} \frac{{S}_{d 2} - {S}_{d 1}}{( {C}_{fc} - 1 ) * {S}_{d 1}} .$$

10. The spectrometer device according to claim 5, wherein the optical measurement element is arranged separated from the detector by a first transparent gap and wherein the optical calibration element is arranged separated from the detector by a second transparent gap.

11. The spectrometer device according to claim 5, wherein the optical measurement element and the optical calibration element are arranged separately from each other.

12. The spectrometer device according to claim 5, wherein the light emitting element is an active optical element configured for switching at least between emitting light along the optical measurement path and emitting light along the optical calibration path.

13. The spectrometer device according to claim 5, wherein the optical calibration element is one or more of a reflector, a metal layer, or a mirror, and wherein the optical measurement element is a transparent window.

14. A method of using a spectrometer device according to claim 5, the method comprising using the spectrometer device in an application selected from the group consisting of an infrared detection application; a spectroscopy application; an exhaust gas monitoring application; a combustion process monitoring application; a pollution monitoring application; an industrial process monitoring application; a mixing or blending process monitoring; a chemical process monitoring application; a food processing process monitoring application; a food preparation process monitoring; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application; an agricultural application, a plastics identification and/or recycling application; and a healthcare and/or beauty application.

15. The spectrometer device according to claim 5, wherein at least one light emitting element is a light emitting diode (LED) configured for emitting light.

16. The spectrometer device according to claim 5, wherein the optical measurement element and the optical calibration element are arranged in separate locations such that a gap exists between the optical measurement element and the optical calibration element.

17. The method according to claim 14, wherein the agricultural application comprises characterization of soil, silage, feed, crop or produce, and/or monitoring plant health.

18. The method according to claim 14, wherein the healthcare and/or beauty application comprises a determining of skin hydration and/or oxygen saturation in an animal or human skin, and a determining of an oxygen saturation in blood, urine, saliva or other bodily fluids.
